(19) United States
(12) Patent Application Publication
(10) Pub. No.: US 2025/0321511 A1
(43) Pub. Date: Oct. 16, 2025

(54) MONOCHROME OPTICAL SCANNING DEVICE AND MONOCHROME IMAGE FORMING APPARATUS

(71) Applicants: Yuji KAWAMATA, Kanagawa (JP); Yoshinobu SAKAUE, Kanagawa (JP); Ryo SATO, Kanagawa (JP)

(72) Inventors: Yuji KAWAMATA, Kanagawa (JP); Yoshinobu SAKAUE, Kanagawa (JP); Ryo SATO, Kanagawa (JP)

(21) Appl. No.: 19/083,495

(22) Filed: Mar. 19, 2025

(30) Foreign Application Priority Data
Apr. 12, 2024 (JP) 2024-064878

(51) Int. Cl. G03G 15/04; G02B 26/08; G02B 26/12; G03G 15/01

(52) U.S. Cl. CPC G03G 15/04045; G02B 26/0816; G02B 26/12; G03G 15/011

(57) ABSTRACT

A monochrome optical scanning device includes a light source to emit light; a deflector to deflect the light emitted from the light source; an optical element to direct the light deflected by the deflector onto a photoconductor; a base mounting the optical element on the base; and a housing. The base has the same shape as the optical element, and the base is made of the same material or the same kind of material as the optical element. The housing is detachably attached to a monochrome image forming apparatus, the housing accommodating the light source, the deflector, the optical element, and the base.

### CROSS-REFERENCE TO RELATED APPLICATION

This patent application is based on and claims priority pursuant to 35 U.S.C. § 119 (a) to Japanese Patent Application No. 2024-064878, filed on Apr. 12, 2024, in the Japan Patent Office, the entire disclosure of which is hereby incorporated by reference herein.

### BACKGROUND

### Technical Field

The present disclosure relates to a monochrome optical scanning device and a monochrome image forming apparatus.

### Related Art

A monochrome optical scanning device mounted on a monochrome image forming apparatus includes an optical element that guides light from a light source deflected and scanned by a deflector onto a photoconductor to form an image.

A two-color optical scanning device with vertically stacked scanning lenses (or optical elements) has been developed as an optical scanning device. This two-color optical scanning device has a red-color scanning lens on the lower stage and a black-color scanning lens on the upper stage, with the black-color scanning lens placed on the red-color scanning lens. To adapt the two-color optical scanning device for a monochrome optical scanning device, the black-color scanning lens is placed on the spacer, replacing the red-color scanning lens.

### SUMMARY

An embodiment of the present disclosure provides a monochrome optical scanning device includes a light source to emit light; a deflector to deflect the light emitted from the light source; an optical element to direct the light deflected by the deflector onto a photoconductor; a base mounting the optical element on the base; and a housing. The base has the same shape as the optical element, and the base is made of the same material or the same kind of material as the optical element. The housing is detachably attached to a monochrome image forming apparatus, the housing accommodating the light source, the deflector, the optical element, and the base.

### BRIEF DESCRIPTION OF THE DRAWINGS

A more complete appreciation of embodiments of the present disclosure and many of the attendant advantages and features thereof can be readily obtained and understood from the following detailed description with reference to the accompanying drawings, wherein:

FIG. 1 is a schematic diagram illustrating a configuration of a monochrome image forming apparatus;

FIG. 2 is a schematic diagram illustrating a configuration of a color image forming apparatus with monochrome image transfer function;

FIG. 3 is a schematic diagram of a monochrome optical scanning device on a monochrome image forming apparatus;

FIG. 4 is a schematic diagram of a color optical scanning device that can be converted for a monochrome optical scanning device;

FIG. 5 is a perspective view of scanning lenses and their surrounding components in the color optical scanning device in FIG. 4;

FIG. 6 is a schematic view of a holder holding a scanning lens;

FIG. 7 is a perspective view of scanning lenses and their surrounding components in a monochrome optical scanning device;

FIG. 8 is a perspective view of a non-standard scanning lens used as a base with an identification mark; and

FIG. 9 is a perspective view of a scanning lens for cyan of a color optical scanning device used as a base in a monochrome optical scanning device.

The accompanying drawings are intended to depict embodiments of the present disclosure and should not be interpreted to limit the scope thereof. The accompanying drawings are not to be considered as drawn to scale unless explicitly noted. Also, identical or similar reference numerals designate identical or similar components throughout the several views.

### DETAILED DESCRIPTION

In describing embodiments illustrated in the drawings, specific terminology is employed for the sake of clarity. However, the disclosure of this specification is not intended to be limited to the specific terminology so selected and it is to be understood that each specific element includes all technical equivalents that have a similar function, operate in a similar manner, and achieve a similar result.

Referring now to the drawings, embodiments of the present disclosure are described below. As used herein, the singular forms “a,” “an,” and “the” are intended to include the plural forms as well, unless the context clearly indicates otherwise.

According to one aspect of the present disclosure, desired optical characteristics can be obtained in a converted monochrome optical scanning device.

Embodiments of the present disclosure will be described with reference to the drawings. It is easy for a person skilled in the art to make other embodiments by changing and modifying the embodiments of the present disclosure within the scope of the claims, and these changes and modifications are included in the scope of the claims. In the following description, the embodiments of the present disclosure are the best mode of the invention and is not intended to limit the scope of the claims.

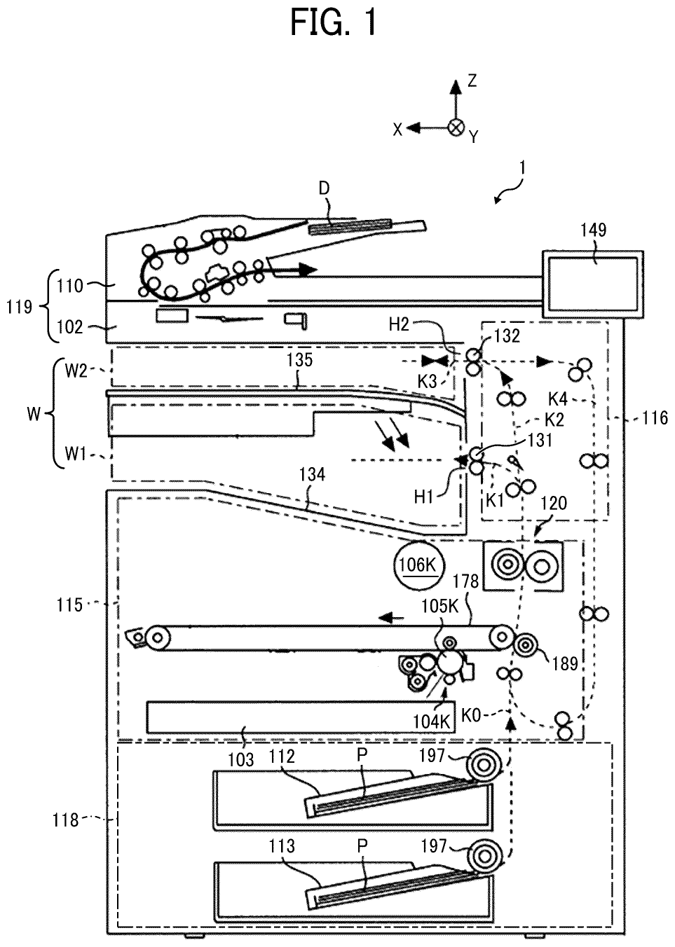

FIG. 1 is a schematic diagram illustrating a configuration of a monochrome image forming apparatus 1.

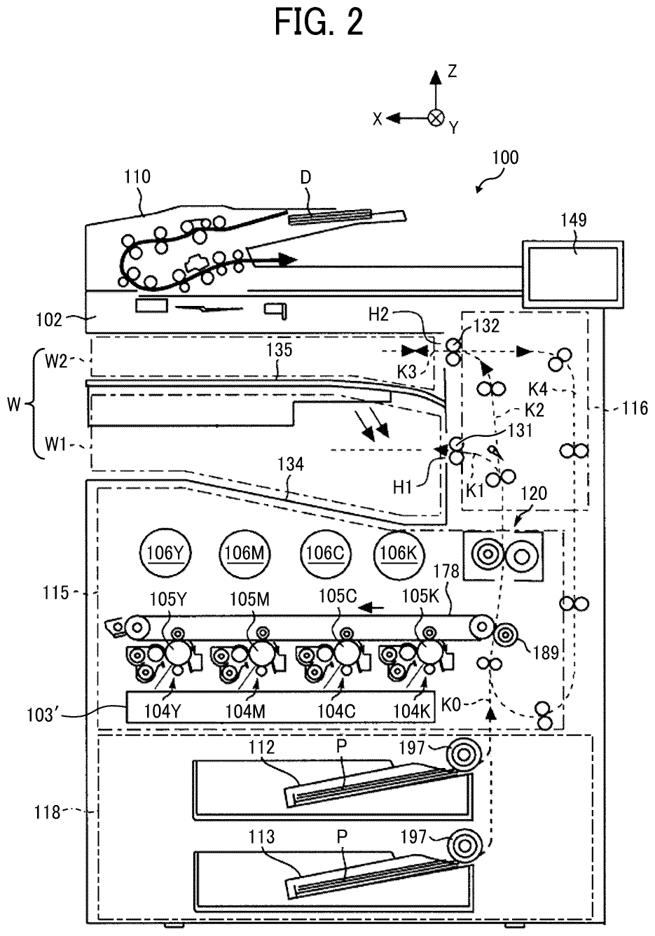

The monochrome image forming apparatus 1 illustrated in FIG. 1 is converted from the color image forming apparatus 100 illustrated in FIG. 2. The converted monochrome image forming apparatus 1 includes a black imaging unit 104K and a black toner bottle 106K, but does not includes color imaging units 104Y, 104M, and 104C and color toner bottles 106Y, 106M, and 106C of the color image forming apparatus 100. The monochrome image forming apparatus 1 shares components, systems, and functions with the color image forming apparatus 100, reducing newly introduced resources and lowering the cost of the apparatus. Further, the monochrome image forming apparatus 1 enhances the recyclability between the monochrome image forming apparatus and the color image forming apparatus.

The monochrome image forming apparatus 1 illustrated in FIG. 1 includes an image forming unit 115, a sheet feed unit 118, an image reader 119 that reads an image of a document D for image formation, and an operation panel 149. The image reader 119 is disposed above the image forming unit 115 and includes a document feeder 110 and a scanner 102. The sheet feed unit 118 is disposed below the image forming unit 115 and includes two feed trays 112 and 113 for accommodating sheets P.

The image forming unit 115 includes the black imaging unit 104K (or an imager), an intermediate transfer belt 178, a monochrome optical scanning device 103, and a secondary transfer roller 189. The intermediate transfer belt 178 serves as an intermediate transferor. A fixing unit 120 for fixing an image on the sheets P is disposed above the secondary transfer roller 189.

The imaging unit 104K includes, around a photoconductor 105K, a charging device that applies electric charges to the surface of the photoconductor 105K, and a development device that develops a latent image formed on the surface of the photoconductor 105K with black toner to form a toner image. A cleaning device is also included to clean the surface of the photoconductor 105K after the toner image is transferred from the photoconductor 105K.

An operation of a monochrome image forming apparatus 1 is described below.

In response to a start instruction for copying a document D input into the operation panel 149, the document D is conveyed (fed) by conveyance rollers of the document feeder 110 from a document tray in a direction indicated by arrow in FIG. 1, and then passes over the scanner 102. At this time, the scanner 102 optically reads image data of the document D as the document D passes over the scanner 102.

The image data optically scanned by the scanner 102 is converted into electrical signals. The electrical signals are then transmitted to the monochrome optical scanning device 103. The monochrome optical scanning device 103 emits laser beams onto the photoconductor 105K based on the electrical signals of the image data, performing an exposure process.

In the monochrome image forming apparatus 1, a charging process, the exposure process, and a developing process are sequentially executed on the photoconductor 105K of the imaging unit 104K to form a desired image on the photoconductor 105K. An image formed on the photoconductor 105K are transferred onto the intermediate transfer belt 178 to form a monochrome image. The monochrome image formed on the intermediate transfer belt 178 is transferred onto the surface of a sheet P fed and conveyed through the sheet feed path K0 by the sheet feed roller 197 from either of the two feed trays 112 and 113. The transfer occurs at the position where the intermediate transfer belt 178 faces the secondary transfer roller 189, as the secondary transfer nip. The sheet P with the transferred monochrome image is conveyed to the position of the fixing unit 120, where the monochrome image is fixed onto the sheet P in the fixing step.

The sheet P after an image has been formed by the image forming unit 115 (i.e., a printed sheet P) is ejected from a first sheet ejection port H1 (or a sheet ejection port) by first ejection rollers 131 through a first sheet ejection path K1 (or a sheet ejection path) of a side protrusion 116. Afterward, the printed sheet P is stacked on a first sheet tray 134 (or sheet tray) in the first space W1.

When a “double-sided printing mode” is selected to form an image on each side (i.e., each of the front and back sides) of the sheet P, the sheet P is directed to a second sheet ejection path K2 (or a sheet relay path) by the action of a switching claw after the image is fixed onto the front side of the sheet P. The sheet P guided to the second sheet ejection path K2 is directed to a sheet reversing path K3. At this time, a rear end of the sheet P is nipped by second ejection rollers 132 (or reversing rollers) while the opposite end is ejected from a second sheet ejection port H2 to the second space W2 on a second sheet tray 135. Subsequently, the direction of conveyance of the sheet P is reversed by the reverse rotation of the second ejection rollers 132 and is conveyed into a duplex printing path K4.

The sheet P guided to the duplex printing path K4 is again conveyed to the position of the secondary transfer nip, i.e., the secondary transfer roller 189. At the secondary transfer nip, another toner image is formed on, or printed onto, the back side of the sheet P in the series of image forming processes (i.e., image forming operation) as described above. Subsequently, the sheet S is subjected to a fixing process in the fixing unit 120 and is ejected from the first sheet ejection port H1 into the first space W1 through the first sheet ejection path K1, and is stacked onto the first sheet tray 134.

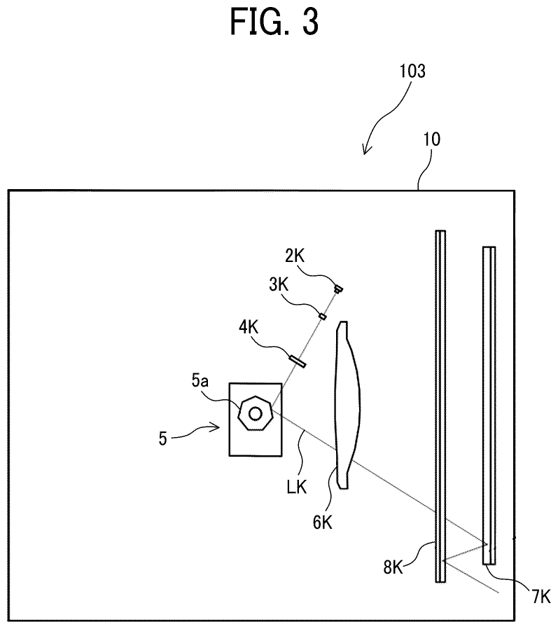

FIG. 3 is a schematic diagram of a monochrome optical scanning device 103 mounted on a monochrome image forming apparatus 1.

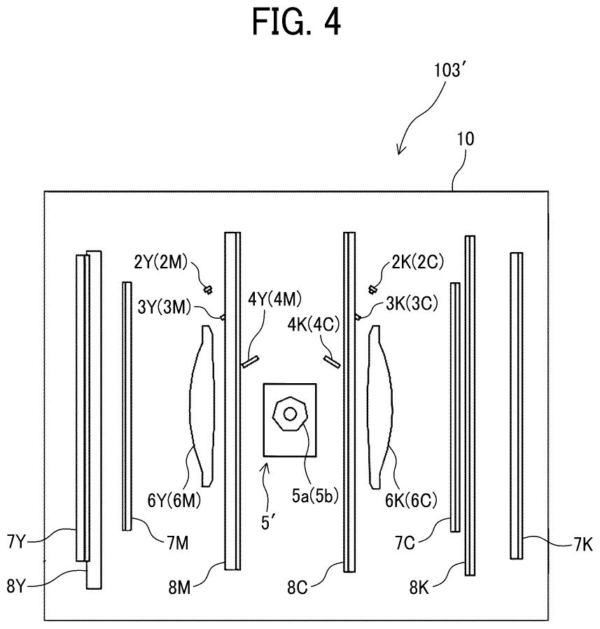

The monochrome optical scanning device 103 is converted from a color optical scanning device 103′ in FIG. 4 mounted on a color image forming apparatus 100 in FIG. 2. The color optical scanning device 103′ includes color light sources 2Y, 2M, and 2C and color optical elements 3Y to 8Y, 3M to 8M, and 3C to 8C, which are not included in the monochrome optical scanning device 103 converted from the color optical scanning device 103′. The monochrome optical scanning device 103 shares, in common with the color optical scanning device 103′, at least a housing 10 as a container, a light source for black (or light source 2K), and optical elements for black (or optical elements 3K to 8K). This configuration eliminates the need for newly introduced resources and reduces the cost of the monochrome image forming apparatus 1. This configuration also enhances the recyclability between the monochrome optical scanning device 103 and the color optical scanning device 103′ in both directions.

The monochrome optical scanning device 103 illustrated in FIG. 3 includes a housing 10, a light source 2K, a collimator lens 3K, a cylindrical lens 4K, a polygon scanner 5, a scanning lens 6K, a first reflecting mirror 7K, and a second reflecting mirror 8K. The polygon scanner 5 includes a polygon mirror 5a serving as a deflector having six mirror surfaces, a polygon motor that rotates the polygon mirror 5a, and a control board that controls the polygon motor.

A monochrome optical scanning device 103 includes a light source 2K to emit light; a deflector (e.g., a polygon mirror 5a) to deflect the light emitted from the light source; an optical element (e.g., a scanning lens 6K) to direct the light deflected by the deflector onto a photoconductor; a base (e.g., a base portion 9) mounting the optical element on the base; and a housing 10. The base has the same shape as the optical element. The base is made of the same material or the same kind of material as the optical element. The housing is detachably attached to a monochrome image forming apparatus, the housing accommodating the light source, the deflector, the optical element, and the base.

The light beam LK from the light source 2K is converted from a divergent beam to a parallel beam by the collimating lens 3K, and then focused in the sub-scanning direction (i.e., the direction of movement of the photoconductor surface) by passing through the cylindrical lens 4K.

The light beam transmitted through the cylindrical lens 4K is deflected in the main scanning direction (i.e., an axial direction on the photoconductor surface) while being reflected by any of the mirror surfaces on the side surfaces of the polygon mirror 5a, which is rotated at a high speed by the polygon motor.

The scanning lens 6K, as an optical element, converts the movement speed of the light deflected in the main scanning direction at a constant angular velocity by the polygon mirror 5a into a uniform linear speed. Further, the light deflected in the main scanning direction is focused in the sub-scanning direction by the scanning lens 6K, and a so-called surface tilt which is the inclination of the mirror surface of the polygon mirror 5a is corrected. The light beam LK transmitted through the scanning lens 6K is reflected by the first reflecting mirror 7K and the second reflecting mirror 8K, and is directed to the surface of the photoconductor 105K (see FIG. 1).

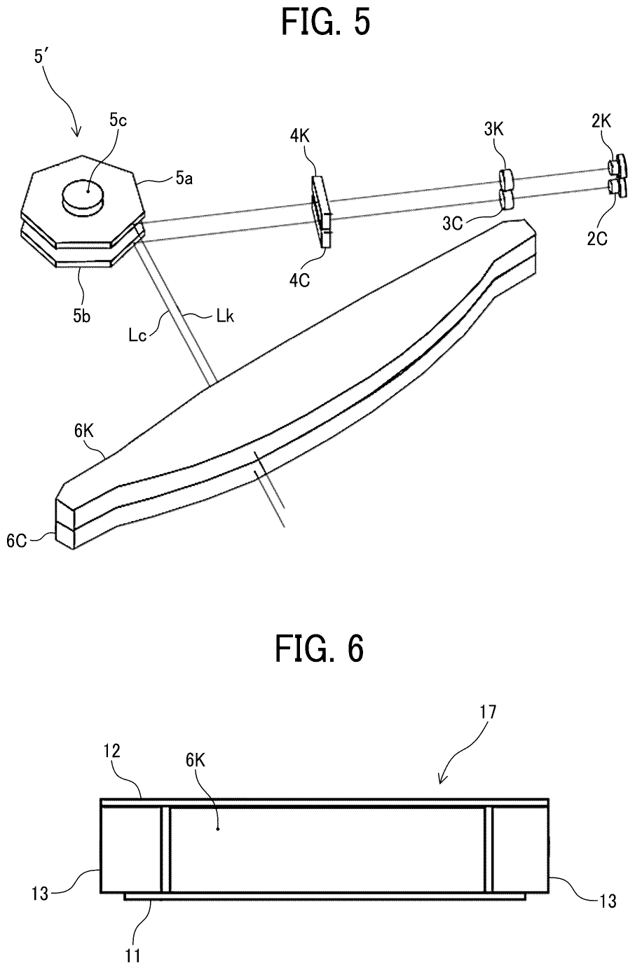

FIG. 5 is a perspective view of scanning lenses and their surrounding components in the color optical scanning device 103′ in FIG. 4.

In the color optical scanning device 103′ as illustrated in FIG. 5, the black optical system is placed on the cyan optical system, and the black scanning lens 6K is mounted and fixed onto the cyan scanning lens. The black scanning lens 6K in the upper stage and the cyan scanning lens 6C in the lower stage are made of the same material and have the same shape.

In a polygon scanner 5′, the high-speed rotations of polygon mirrors 5a and 5b generate heat in a bearing that supports a rotation shaft 5c of the polygon mirrors 5a and 5b. As a result, the area surrounding the polygon mirrors 5a and 5b heats up, causing the scanning lenses 6C and 6K to thermally expand. In the color optical scanning device 103′, the arrangement and optical characteristics of the optical elements, including the scanning lenses, are designed to maintain the desired optical performance even when the orientations of the scanning lenses 6C and 6K change due to thermal expansion.

When the color optical scanning device 103′ is converted into the monochrome optical scanning device 103, changing the mounting member of the black scanning lens 6K from the cyan scanning lens in the lower stage to a base portion (or a base) made of a different material and shape may cause the following issues. That is, when the base portion thermally expands due to the heating of the area surrounding the polygon mirror, its expansion behavior differs from that of the cyan scanning lens 6C. As a result, the orientation and vertical position of the scanning lens 6K also differ from those when it is mounted on the cyan scanning lens 6C. As a result, the incident angle of light entering the scanning lens 6K when thermally expanded differs between the monochrome and color optical scanning devices. Consequently, the desired optical characteristics of the black scanning lens 6K, which are achieved in the color optical scanning device when the temperature rises, may not be obtained in the monochrome optical scanning device.

In view of this, for example, when the color optical scanning device is used as the monochrome optical scanning device, the scanning lens 6K may be held by a holder 17 as illustrated in FIG. 6 to minimize its orientation change due to the temperature increase of the optical scanning device. The holder 17 illustrated in FIG. 6 includes a lower sheet metal plate 11, an upper sheet metal plate 12, and a spacer 13. Both ends of the lower sheet metal plate 11 and the upper sheet metal plate 12 in their longitudinal direction (or the main scanning direction) are fastened to the spacers 13, respectively. The distance between the lower sheet metal plate 11 and the upper sheet metal plate 12 is set to be equal to or less than the height of the scanning lens 6K in the sub-scanning direction (or the vertical direction). The scanning lens 6K is fixed between the lower sheet metal plate 11 and the upper sheet metal plate 12. The lower sheet metal plate 11 and the upper sheet metal plate 12 are independently fastened to the spacers 13 with individual screws. Each spacer 13 is molded from a material with the same coefficient of linear expansion as the scanning lens 6K. This minimizes the difference in thermal deformation between the scanning lens 6K and each metal plate, maintaining a constant compressive force on the scanning lens 6K even with temperature changes in the optical scanning device. As a result, changes in the orientation of the scanning lens 6K due to temperature rise can be minimized.

However, in the configuration illustrated in FIG. 6, when converting from color to monochrome, a dedicated holder for monochrome is used. This may raise concerns that the reduction in newly introduced resources and overall costs is insufficient.

It is also conceivable to convert from color to monochrome by installing only the cyan optical system in the lower stage, and using this cyan optical system in the lower stage to write a latent image for black. This configuration, however, may involve changes to its system and functions, leading to insufficient reduction of newly introduced resources and overall costs. In other words, when converting from color to monochrome, the black optical system for the monochrome optical scanning device is placed at the same position as that of the color optical scanning device, enabling the system and functions for imaging monochrome images in the color optical scanning device/image forming apparatus to be used as is for the monochrome optical scanning device/image forming apparatus. This achieves reduction of newly introduced resources and overall costs.

The monochrome optical scanning device 103 uses a base portion for mounting and fixing the scanning lens 6K, which is made of the same kind of material and has the same shape as the scanning lens 6K.

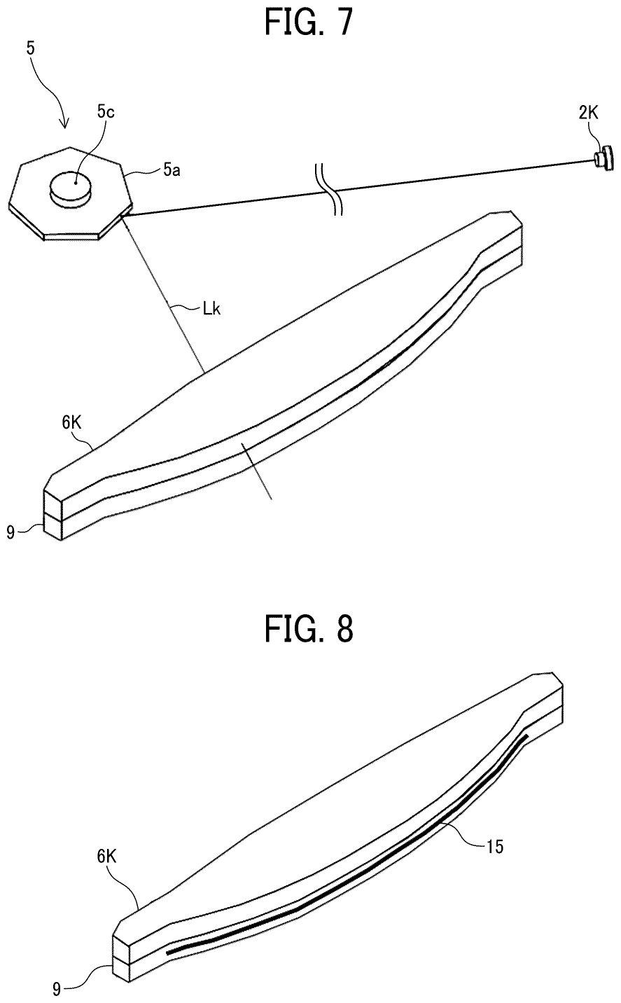

FIG. 7 is a perspective view of scanning lenses and their surrounding components in a monochrome optical scanning device 103.

As illustrated in FIG. 7, the monochrome optical scanning device 103 uses, as a base portion 9 (or a base), a scanning lens that failed to meet optical specifications during manufacturing or reuse/recycling. This allows the shape and material of the base portion 9 to be the same as those of the scanning lens 6K.

By using a non-standard scanning lens as the base portion 9 for mounting the black scanning lens 6K, as described above, the shape and material of the base portion 9 can be designed to match those of the scanning lens 6K. In the color optical scanning device 103′, as described above, the cyan scanning lens 6C on which the black scanning lens 6K is mounted has the same shape and material as those of the black optical scanning lens 6K. By using a non-standard scanning lens as the base portion 9 for mounting the black scanning lens 6K, as described above, the shape and material of the base portion 9 can be designed to match those of the scanning lens 6K, also matching those of the cyan scanning lens 6C. This configuration allows the thermal expansion of the base portion 9 to match the thermal expansion of the cyan scanning lens 6C on which the black scanning lens 6K is mounted and fixed, in the color optical scanning device. Thus, the orientation and other characteristics of the scanning lens 6K, mounted on the base portion 9 of the monochrome optical scanning device converted from the color optical scanning device, during temperature rise within the device can be made the same as in the color optical scanning device, achieving the desired optical characteristics. By using a non-standard scanning lens, which would usually be discarded, as the base portion 9, cost reduction and resource conservation through reduced material usage can be achieved.

To distinguish a scanning lens with optical characteristics out of specification used as the base portion 9 from the black scanning lens 6K during assembly, an identification mark 15 may be added to the non-standard scanning lens, as illustrated in FIG. 8. In FIG. 8, a black line is drawn on the emission surface of the scanning lens as the identification mark 15. As described above, adding the identification mark 15 to the non-standard scanning lens used as the base portion 9 prevents the non-standard scanning lens from being assembled as the black scanning lens.

As illustrated in FIG. 8, it is preferable to provide the identification mark 15 on the emission or incidence surface of the scanning lens used as the base portion. By providing the identification mark 15 on the light-transmitting areas of the incidence or emission surface of the scanning lens used as the base portion, the mark can obstruct light transmission through the scanning lens. As a result, even if a non-standard scanning lens is mistakenly assembled as the black scanning lens, an abnormality is detected during the characteristic value inspection process or the product (image forming apparatus) verification process. This allows the detection of misassembly occurrences.

The formation position of the identification mark 15 is not limited to the incidence or emission surface of the scanning lens, nor are its shape and color limited to those illustrated in FIG. 8

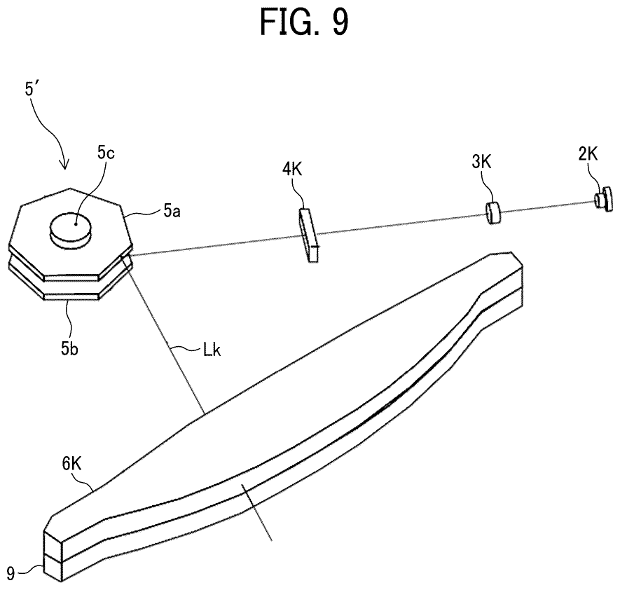

Further, as illustrated in FIG. 9, the color polygon scanner with the two-level polygon mirrors 5a and 5b may be directly adapted for monochrome use. Further, as illustrated in FIG. 9, the cyan scanning lens 6C used in the color optical scanning device 103′ may be directly used as the base portion 9. Since the magenta and yellow scanning lenses have the same shape and are made of the same material as the cyan scanning lens, the magenta scanning lens 6M and the yellow scanning lens 6Y may also be repurposed as base portions.

Although the desirable embodiments and examples of the disclosure have been described above, the disclosure is not particularly limited to such specific embodiments and examples unless otherwise particularly limited in the above description, and various modifications and changes can be made without departing from the spirit and scope of the disclosure as set forth in the appended claims.

The above description is merely one example, and the following aspects yield unique effects.

### Aspect 1

A monochrome optical scanning device 103 mounted on a monochrome image forming apparatus 1 includes a light source to emit light; a deflector (e.g., a polygon mirror 5a) to deflect the light emitted from the light source; a base (a base portion 9); and an optical element (e.g., a scanning lens 6K) on the base. The optical element directs the light deflected by the deflector onto the surface of a photoconductor. The base has the same shape as the optical element; and is made of the same or same kind of material as the optical element. In a multiple-color optical scanning device, such as a two-color optical scanning device, a lower optical element on which an upper optical element is mounted has the same shape and is made of the same kind of material as those of the upper optical element.

The high-speed rotation of the deflector heats up a rotation shaft to which the deflector is fixed, increasing the temperature in the image forming apparatus. When a monochrome optical scanning device is converted from a multiple-color optical scanning device, changing a member on which an upper optical element is mounted from the lower optical element to a base portion, such as a spacer, with material and shape different from those of the lower optical element, can lead to the following issues: Specifically, the difference in shape and material between the base portion and the lower optical element results in different thermal expansion therebetween when the temperature increases in the image forming apparatus. Thus, when the temperature rises in the monochrome optical scanning device, the orientation of the upper optical element differs from the orientation when the upper optical element is used as a multi-color optical scanning device. This results in a different incident angle of light entering the optical element between the monochrome and color optical scanning devices. Consequently, the desired optical characteristics of the upper optical element, achieved in the color optical scanning device when the temperature rises, may not be obtained in the monochrome optical scanning device.

In the configuration of Aspect 1, however, using a base portion with the same or similar material and shape as an upper optical element allows its thermal expansion to closely match that of the lower optical element, which also has the same or similar material and shape as the upper optical element mounted on the lower optical element. Thus, during a temperature rise in the image forming apparatus, the orientation and other characteristics of the optical element mounted on the base portion of the monochrome optical scanning device, converted from the color optical scanning device, can be maintained as in the color optical scanning device, achieving the desired optical characteristics.

### Aspect 2

In the aspect 1, the base (e.g., the base portion 9) is another optical element such as a scanning lens having an optical characteristic that is out of specification.

This configuration allows an optical element, such as a non-standard scanning lens that would usually be discarded, to be reused as the base portion, achieving lower costs and resource conservation through reduced material consumption.

### Aspect 3

In Aspect 1, the base (e.g., the base portion 9) is another optical device, such as a scanning lens 6C, used in the color optical scanning device 103′ attached to a color image forming apparatus, to perform optical scanning on multiple photoconductors.

This configuration allows the base portion for mounting an optical element, such as a scanning lens, to have the same or similar material and the same shape as the optical element.

### Aspect 4

In any one of Aspects 1 to 3, a housing of the color optical scanning device mounted on the color image forming apparatus that performs optical scanning onto multiple photoconductors is used as a housing 10 that accommodates a light source 2K, a deflector, such as a polygon mirror, and an optical element, such as a scanning lens 6.

Specifically, the same housing is used for both of: the monochrome optical scanning device to perform optical scanning onto a single photoconductor; and a color optical scanning device to perform optical scanning onto multiple photoconductors.

This configuration allows the color image forming apparatus and the monochrome image forming apparatus to share the same housing, reducing the need for newly introduced resources and overall costs. This enhances the recyclability between color and monochrome in both directions.

### Aspect 5

In any one of Aspects 1 to 4, the base (e.g., the base portion 9) is marked to identify the base portion as a base.

Specifically, the base has a marking to identify that the base is used for mounting the optical element; and that the base is not for use as the optical element.

According to this configuration, as described above, the base portion made of the same or similar material and shape as the optical element (or the scanning lens) can be distinguished from the optical element by the identification mark. This can prevent the base portion from being erroneously assembled as an optical element.

### Aspect 6

A monochrome image forming apparatus includes the monochrome optical scanning device according to any one of Aspects 1 to 5 to scan the light onto a surface of the photoconductor to form a latent image of the light thereon; and an imager to develop the latent image with black toner to form a toner image on the surface of the photoconductor.

According to this configuration, a favorable monochrome image can be formed.

The above-described embodiments are illustrative and do not limit the present invention. Thus, numerous additional modifications and variations are possible in light of the above teachings. For example, elements and/or features of different illustrative embodiments may be combined with each other and/or substituted for each other within the scope of the present invention.

1. A monochrome optical scanning device comprising:
a light source to emit light;
a deflector to deflect the light emitted from the light source;
an optical element to direct the light deflected by the deflector onto a photoconductor;
a base mounting the optical element on the base,
the base having the same shape as the optical element,
the base made of the same material or the same kind of material as the optical element; and
a housing detachably attached to a monochrome image forming apparatus, the housing accommodating the light source, the deflector, the optical element, and the base.

2. The monochrome optical scanning device according to claim 1,
wherein the base is another optical element with optical characteristics out of specification.

3. The monochrome optical scanning device according to claim 1,
wherein the base is another optical element used in a color optical scanning device attached to a color image forming apparatus.

4. The monochrome optical scanning device according to claim 1,
wherein the same housing is used for both of:
the monochrome optical scanning device to perform optical scanning onto a single photoconductor; and
a color optical scanning device to perform optical scanning onto multiple photoconductors.

5. The monochrome optical scanning device according to claim 1,
wherein the base has a marking to identify:
that the base is used for mounting the optical element; and
that the base is not for use as the optical element.

6. A monochrome image forming apparatus comprising:
the monochrome optical scanning device according to claim 1 to scan the light onto a surface of the photoconductor to form a latent image of the light thereon; and
an imager to develop the latent image with black toner to form a toner image on the surface of the photoconductor.
